(19) United States
(12) Patent Application Publication
(10) Pub. No.: US 2026/0120407 A1
(43) Pub. Date: Apr. 30, 2026

(54) IMAGE PROCESSING METHOD, ELECTRONIC DEVICE AND NON-TRANSISTORY COMPUTER READABLE MEDIUM

(71) Applicant: Beijing Zitiao Network Technology Co., Ltd., Beijing (CN)

(72) Inventors: Dongrui LI, Beijing (CN); Dayu QIU, Beijing (CN); Xumin DING, Beijing (CN)

(21) Appl. No.: 19/370,616

(22) Filed: Oct. 27, 2025

(30) Foreign Application Priority Data
Oct. 28, 2024 (CN) 202411515536.7

(51) Int. Cl. G06T 17/20

(52) U.S. Cl. CPC G06T 17/20

(57) ABSTRACT

The present disclosure relates to an image processing method, an electronic device and a non-transitory computer-readable storage medium, where the image processing method includes: obtaining a first image to be processed, and obtaining a first mesh; determining a first mapping relationship between the first image and the first mesh, and determining vertex pixel information of the first mesh based on the first mapping relationship and the first image; obtaining a target distortion parameter, and adjusting a position of each of vertices of the first mesh in a three-dimensional space based on the vertex pixel information of the first mesh and the target distortion parameter to obtain a second mesh; and generating a target image based on the second mesh.

### CROSS-REFERENCE TO RELATED APPLICATION

This application claims the priority to and benefits of the Chinese Patent Application No. 202411515536.7, which was filed on October 28, 2024. The aforementioned patent application is hereby incorporated by reference in its entirety.

### TECHNICAL FIELD

The present disclosure relates to an image processing method, an electronic device and a non-transitory computer readable medium.

### BACKGROUND

Nowadays, an increasing number of ordinary users, professional video editors require and other people need to use multimedia editing software to edit multimedia materials such as captured images. Most of existing multimedia editing software may provide effect processing functions, such as adding effects to images uploaded by users, thereby enhancing the appeal, fun and so on of the videos. However, the inventors have found through research that the types of existing image effects are limited and it is difficult to meet the diverse needs of users. Therefore, new image effects are urgently needed at present.

### SUMMARY

In order to solve the above technical problems or at least partially solve the above technical problems, the present disclosure provides an image processing method, an electronic device and a non-transitory computer readable medium.

An embodiment of the present disclosure provides an image processing method. The image processing method includes: obtaining a first image to be processed, and obtaining a first mesh; determining a first mapping relationship between the first image and the first mesh, and determining vertex pixel information of the first mesh based on the first mapping relationship and the first image; obtaining a target distortion parameter, and adjusting a position of each of vertices of the first mesh in a three-dimensional space based on the vertex pixel information of the first mesh and the target distortion parameter to obtain a second mesh; and generating a target image based on the second mesh.

Optionally, the obtaining the first mesh includes: respectively constructing corresponding sub-meshes by using a plurality of processes, where the sub-meshes includes planar meshes with M rows and N columns, and both M and N are preset positive integers; and merging a plurality of the sub-meshes to obtain the first mesh.

Optionally, the first mesh is a planar mesh, and the determining the first mapping relationship between the first image and the first mesh, includes: determining the first mapping relationship based on information of a ratio between a size of the first image and a size of the first mesh.

Optionally, the determining vertex pixel information of the first mesh based on the first mapping relationship and the first image, includes: determining a sampling position corresponding to each of the vertices of the first mesh, determining a pixel corresponding to the sampling position in the first image based on the first mapping relationship, and taking pixel information of the pixel as vertex pixel information of the first mesh, where the pixel information of the pixel includes at least one selected from a group consisting of brightness information and color information of the pixel.

Optionally, an abscissa of the sampling position corresponding to each of the vertices includes an abscissa of each of the vertices or an abscissa of a specified position of a fragment to which each of the vertices belong in the first mesh; and an ordinate of the sampling position corresponding to each of the vertices includes an ordinate of each of the vertices or an ordinate of the specified position of the fragment to which each of the vertices belongs in the first mesh.

Optionally, the target distortion parameter is a preset adjustable parameter, the target distortion parameter includes a distortion axis and a maximum distortion angle, and the maximum distortion angle is a maximum angle at which each of the vertices in the first mesh rotates around the distortion axis; and the adjusting the position of each of the vertices of the first mesh in the three-dimensional space based on the vertex pixel information of the first mesh and the target distortion parameter to obtain the second mesh, includes: determining a target angle at which each of the vertices of the first mesh rotates around the distortion axis based on the vertex pixel information of the first mesh and the maximum distortion angle; and adjusting the position of each of the vertices of the first mesh in the three-dimensional space based on the distortion axis and the target angle to obtain the second mesh.

Optionally, the vertex pixel information includes a vertex brightness value or a vertex color value, and the determining the target angle at which each of the vertices of the first mesh rotates around the distortion axis based on the vertex pixel information of the first mesh and the maximum distortion angle, includes: obtaining, based on the maximum distortion angle, a second mapping relationship between the vertex pixel information of the first mesh and the angle at which each of the vertices of the first mesh rotates around the distortion axis, where the second mapping relationship is characterized by a positive correlation function or a negative correlation function; and determining the target angle at which each of the vertices of the first mesh rotates around the distortion axis based on the vertex pixel information of the first mesh and the second mapping relationship.

Optionally, the adjusting the position of each of the vertices of the first mesh in the three-dimensional space based on the distortion axis and the target angle to obtain the second mesh, includes: adjusting the position of each of the vertices of the first mesh in the three-dimensional space based on the distortion axis and the target angle to obtain vertex position information of the second mesh; determining vertex pixel information of the second mesh based on the vertex position information of the second mesh and the vertex pixel information of the first mesh; determining fragment pixel information of the first mesh based on at least one selected from a group consisting of the first mapping relationship and the vertex pixel information of the first mesh; performing, based on the vertex pixel information of the second mesh, a depth adjustment operation and a fragment edge feathering operation on the fragment pixel information of the first mesh to obtain fragment pixel information of the second mesh; and obtaining the second mesh based on the vertex pixel information and the fragment pixel information of the second mesh.

Optionally, the obtaining the second mesh based on the vertex pixel information and the fragment pixel information of the second mesh, includes: obtaining a preset stylization parameter, where the stylization parameter includes at least one selected from a group consisting of a first parameter and a second parameter, the first parameter indicates that target edge lines of the second mesh are subjected to transparency processing, and the second parameter indicates that target fragments of the second mesh is subjected to transparency processing; adjusting transparency in the vertex pixel information and the fragment pixel information of the second mesh based on the stylization parameter; and obtaining the second mesh based on the vertex pixel information and the fragment pixel information of the second mesh after the transparency is adjusted.

Optionally, the generating the target image based on the second mesh, includes: obtaining parameter information of a projection camera, where the parameter information includes an observation angle and a focal length, the observation angle indicates a viewing angle of the projection camera relative to the second mesh, and the focal length indicates a distance between the projection camera and the second mesh; and performing screen display processing on the second mesh based on the parameter information of the projection camera to obtain the target image.

An embodiment of the present disclosure also provides an image processing apparatus, including: a first mesh obtaining module configured to obtain a first image to be processed and obtain a first mesh; a vertex pixel determining module configured to determine a first mapping relationship between the first image and the first mesh, and determine vertex pixel information of the first mesh based on the first mapping relationship and the first image; a second mesh obtaining module configured to obtain a target distortion parameter, and adjust a position of each of vertices of the first mesh in a three-dimensional space based on the vertex pixel information of the first mesh and the target distortion parameter to obtain a second mesh; and a target image generation module configured to generate a target image based on the second mesh.

An embodiment of the present disclosure also provides an electronic device, including: a processor; a memory configured to store instructions executable by the processor, the processor being configured to read the executable instructions from the memory and executing the instructions to implement the image processing method provided by the embodiment of the present disclosure.

An embodiment of the present disclosure also provides a non-transitory computer-readable storage medium storing a computer program for executing the image processing method provided by the embodiment of the present disclosure.

It should be understood that the content described in this section is not intended to identify key or important features of the embodiments of the present disclosure, nor is it intended to limit the scope of the present disclosure. Other features of the present disclosure will be readily understood from the following description.

### BRIEF DESCRIPTION OF DRAWINGS

The accompanying drawings, which are incorporated in and constitute a part of this description, illustrate embodiments consistent with the present disclosure and, together with the description, serve to explain the principles of the present disclosure.

In order to more clearly illustrate the embodiments of the present disclosure or technical solutions in the related art, the drawings required for describing the embodiments or the related art will be briefly described below, and it is obvious for those skilled in the art to obtain other drawings without inventive labor.

FIG. 1 is a flow diagram of an image processing method according to an embodiment of the present disclosure;

FIG. 2 is a schematic diagram of construction of a first mesh according to an embodiment of the present disclosure;

FIG. 3 is a schematic diagram of a second mesh according to an embodiment of the present disclosure;

FIG. 4 is a schematic diagram of an image processing flow according to an embodiment of the present disclosure;

FIG. 5 is a schematic diagram of an image processing effect according to an embodiment of the present disclosure;

FIG. 6 is a structural schematic diagram of an image processing apparatus according to an embodiment of the present disclosure;

FIG. 7 is a structural schematic diagram of an electronic device according to an embodiment of the present disclosure.

### DETAILED DESCRIPTION

In order that the above objects, features and advantages of the present disclosure m be more clearly understood, aspects of the present disclosure will be further described below. It should be noted that, in the absence of conflict, embodiments of the present disclosure and features in the embodiments may be combined with each other.

In the following description, numerous specific details are set forth in order to provide a thorough understanding of the present disclosure. However, the present disclosure may also be implemented in other ways different from those described herein. Apparently, the embodiments disclosed in the description are only a part of embodiments of the present disclosure, rather than all the embodiments.

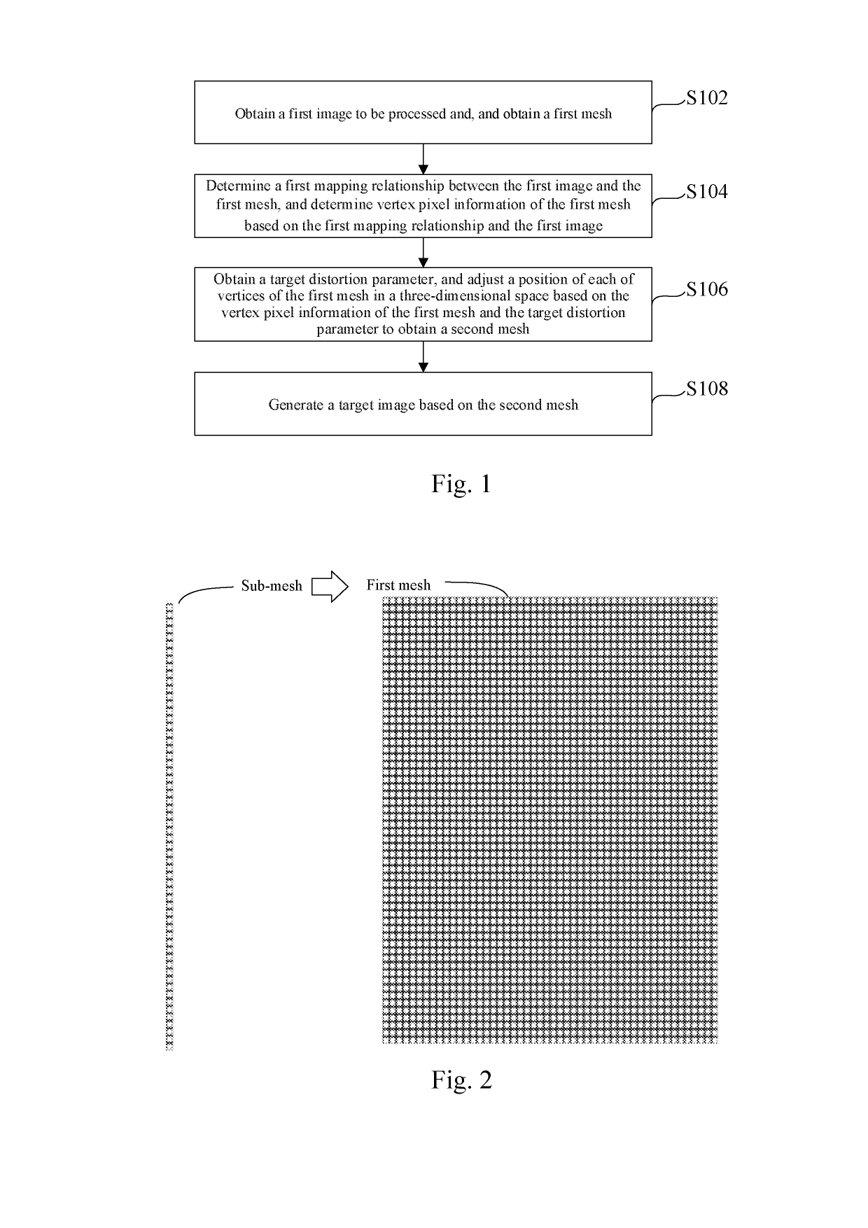

FIG. 1 is a flow diagram of an image processing method according to an embodiment of the present disclosure. The method may be executed by an image processing apparatus, which may be implemented by software and/or hardware and generally integrated in an electronic device. As shown in FIG. 1, the method mainly includes the following steps S102 to S108.

At step S102, a first image to be processed and a first mesh are obtained.

The embodiment of the present disclosure does not limit content of the first image. For example, the first image may be any image that requires three-dimensional (3D) distortion effect processing. Exemplarily, the first image may be a planar image, that is, a two-dimensional (2D) image. In the embodiment of the present disclosure, the first mesh may be obtained, and the first mesh may be a pre-constructed planar mesh. In some implementations, a mesh size, a mesh number and the like of the first mesh may be flexibly set as necessary. In other words, parameters of the first mesh may be directly preset without establishing the first mesh based on the first image.

At step S104, a first mapping relationship between the first image and the first mesh is determined, and vertex pixel information of the first mesh is determined based on the first mapping relationship and the first image.

In order to present the pixel information of the first image through the first mesh, in other words, to map the first image onto the first mesh, the first mapping relationship between the first image and the first mesh may be determined first, an association is established between the first image and the first mesh, and then the pixel information corresponding to vertices of the first mesh is determined from the first image based on the first mapping relationship, thereby obtaining the vertex pixel information of the first mesh.

At step S106, a target distortion parameter is obtained, and a position of each of vertices of the first mesh in a three-dimensional space is adjusted based on the vertex pixel information of the first mesh and the target distortion parameter to obtain a second mesh.

Because the first mesh is a planar mesh mapped with pixel information of the first image, in order to achieve a three-dimensional distortion effect, according to the embodiment of the present disclosure, the positions of the vertices of the first mesh in the three-dimensional space may be adjusted based on the target distortion parameter, thereby obtaining the second mesh in the three-dimensional space, that is, the second mesh is a three-dimensional stereoscopic mesh.

At step S108, a target image is generated based on the second mesh.

The second mesh is a three-dimensional stereoscopic mesh obtained by adjusting the position of the vertex of the first mesh, and the pixel information of the first image is also mapped on the second mesh, that is, a stereoscopic effect of the first image may be obtained efficiently and conveniently by the above-mentioned method. When the second mesh is projected by means of a projection camera, the target image with the three-dimensional distortion effect may be obtained. Specifically, when the first image includes the target object, the target image includes the target object with the three-dimensional distortion effect. Moreover, if the target distortion parameters is different, the three-dimensional distortion effect of first image content presented by the second mesh is different. In addition, if a projection mode is different, for example, if the viewing angle and the focal length of the projection camera are different, the distortion perception of the target object presented in the projected target image is also different. Thereby three-dimensional distortion effects which are rich, interesting and visually appealing may be provided to the users, and the image effect requirements of the users may be met.

In some implementations, the above step of obtaining the first mesh may be performed with reference to the following steps 1 and 2.

At step 1, corresponding sub-meshes are respectively constructed by using a plurality of processes, where the sub-meshes includes planar meshes with M rows and N column, with both M and N being preset positive integers. In practical application, the plurality of processes may be used to construct corresponding sub-meshes at the same time, thus ensuring the efficiency of mesh construction. The sub-meshes with M rows and N columns constructed by each process may be collectively referred to as an instance. For the convenience of implementation, in some implementation examples, the value of M is greater than one, and the value of N is equal to one. In other implementation examples, the value of M is equal to one, and the value of N is greater than 1. In other implementation examples, both values of M and N are greater than 1, and M and N may be the same or different, which may be flexibly set.

At step 2, merging the plurality of the sub-meshes to obtain the first mesh. The first mesh is a planar mesh. Specifically, the sub-meshes may be combined on a row or column basis, which may be set flexibly. For ease of understanding, reference may be made to a schematic diagram of the construction of the first mesh shown in FIG. 2. Multiple independent instances may be created by a multi-instance technology, and each instance corresponds to a sub-mesh. In FIG. 2, by taking the sub-mesh being a column of meshes as an example, the plurality of sub-meshes constructed at the same time are merged to obtain the first mesh efficiently and reliably. As shown in FIG. 2, vertices of the first mesh are located at intersection points of lines in the first mesh. Grids in the first mesh may be regarded as fragments of the first mesh, and may also be called patches. In practical application, the first mesh may be constructed by triangle, in which one grid is formed by splicing two triangles, or each triangle may be directly regarded as a fragment of the first mesh. Through the above-mentioned methods, the first mesh may be efficiently constructed, and it has relatively strong mesh construction performance.

On the basis that the first mesh is the planar mesh, the determining the first mapping relationship between the first image and the first mesh includes: determining the first mapping relationship based on information of a ratio between a size of the first image and a size of the first mesh. Specifically, the above size may be characterized by length and width. For example, the information of the ratio includes: a ratio between a length of the first image and a length of the first mesh, and a ratio between a width of the first image and a width of the first mesh. Then the first mapping relationship between the first image and the first mesh may be determined based on the above ratios, so that the pixel information of the first image may be accurately mapped to the first mesh in the subsequent process, enabling the first mesh to present the pixel information of the first image.

On the basis of obtaining the first mapping relationship, the embodiment of the present disclosure provides an implementation of determining vertex pixel information of the first mesh based on the first mapping relationship and the first image, including: determining a sampling position corresponding to each of the vertices of the first mesh, determining a pixel corresponding to the sampling position in the first image based on the first mapping relationship, and taking pixel information of the pixel as vertex pixel information of the first mesh, where the pixel information of the pixel includes brightness information and/or color information of the pixel. The sampling position is a pixel position in the first image required by the vertex, and the pixel information obtained by sampling this position is the vertex pixel information of the first mesh. Through the above method, the pixel information in the first image corresponding to each vertex in the first mesh may be conveniently and quickly determined and used as the vertex pixel information of the first mesh, so that the pixel information of the first image may be presented through the first mesh.

Exemplarily, an abscissa of the sampling position corresponding to the vertex is: an abscissa of the vertex or an abscissa of a specified position of a fragment to which the vertex belongs in the first mesh; and an ordinate of the sampling position corresponding to the vertex is: an ordinate of the vertex or an ordinate of the specified position of the fragment to which the vertex belongs in the first mesh. Taking a grid in the first mesh as a fragment as an example, the above-mentioned specified position may be a center position of the grid. Exemplarily, by taking the pixel information including brightness information as an example, for each vertex in the first mesh, an X position of a center of the grid to which the vertex belongs and a Y position where the vertex is located are taken as the sampling positions corresponding to the vertex, so as to sample a corresponding brightness value from the first image as the pixel information of the vertex.

In some implementations, the target distortion parameter is a preset adjustable parameter, the target distortion parameter includes a distortion axis and a maximum distortion angle. The maximum distortion angle is a maximum angle at which the vertex in the first mesh rotates around the distortion axis; and the distortion axis is a preset axis around which the mesh vertices need to rotate. On this basis, the above-mentioned step of adjusting a position of a vertex of the first mesh in a three-dimensional space based on the vertex pixel information of the first mesh and the target distortion parameter to obtain a second mesh may be performed with reference to the following steps A and B.

At step A, a target angle, at which the vertex of the first mesh rotates around the distortion axis, is determined based on the vertex pixel information of the first mesh and the maximum distortion angle. That is, the target angle has a certain correlation with the vertex pixel information, and the target angle does not exceed the maximum distortion angle. Through the above method, the position of the vertex of the first mesh may be reasonably adjusted based on the vertex pixel information, which is more in line with a visual perception. In some specific implementation examples, the vertex pixel information includes a vertex brightness value or a vertex color value; the step A may be executed with reference to the following steps A1 to A2.

At step A1, based on the maximum distortion angle, a second mapping relationship between the vertex pixel information of the first mesh and the angle at which the vertex of the first mesh rotates around the distortion axis is obtained, where the second mapping relationship is characterized by a positive correlation function or a negative correlation function. For example, when the vertex pixel information is a vertex brightness value, an angle at which the vertex rotates around the distortion axis may be determined based on the vertex brightness value, such as when the second mapping relationship is characterized by a positive correlation function, the greater the vertex brightness value is, the greater the rotation angle of the vertex is, and when the second mapping relationship is characterized by a negative correlation function, the smaller the vertex brightness value is, the greater the rotation angle of the vertex is. The above positive correlation function or negative correlation function m be set flexibly according to requirements, and the maximum distortion angle may be used as an endpoint parameter of the positive correlation function or negative correlation function to constrain the positive correlation function or negative correlation function to represent the second mapping relationship between zero degree and the maximum distortion angle.

At step A2, the target angle, at which the vertex of the first mesh rotates around the distortion axis, is determined based on the vertex pixel information of the first mesh and the second mapping relationship. The target angle is positively or negatively correlated with the vertex pixel information. By taking the vertex pixel information as the vertex brightness value, in this way, three-dimensional rotation may be made around the distortion axis based on the brightness value, thus presenting a three-dimensional distortion effect with stereo perception.

At step B, the position of the vertex of the first mesh in the three-dimensional space is adjusted based on the distortion axis and the target angle to obtain the second mesh. The vertex of the first mesh is rotated from the current position around the distortion axis by the target angle, so that the position of the vertex of the first mesh after rotation may be obtained. The mesh with the adjusted vertex position is the second mesh, in other words, the second mesh is the mesh after adjusting the vertex position of the first mesh. Because the above positions are adjusted in three-dimensional space, the adjusted vertex positions are not all in the same plane. Through the above method according to the embodiment of the present disclosure, the vertex position of the initially preset planar mesh may be distorted based on the pixel information of the first image, thereby obtaining a three-dimensional stereoscopic mesh (second mesh) with the pixel information of the first image.

In some specific implementation examples, the step B may be executed with reference to the following steps B1 to B5.

At step B1, the position of the vertex of the first mesh in the three-dimensional space based on the distortion axis and the target angle to obtain vertex position information of the second mesh.

At step B2, vertex pixel information of the second mesh is determined based on the vertex position information of the second mesh and the vertex pixel information of the first mesh.

Because the first mesh is the planar mesh, the vertex pixel information of the first mesh usually does not include depth information; and the vertices of the second mesh are the vertices of the first mesh after being adjusted in the three-dimensional space, thus the vertex pixel information of the second mesh adds additional depth information on the basis of the original vertex pixel information of the first mesh. The depth information may be determined based on the vertex position information.

At step B3, fragment pixel information of the first mesh is determined based on the first mapping relationship and/or the vertex pixel information of the first mesh. In some implementations, the pixel information corresponding to fragments of the first mesh may be searched from the first image directly based on the first mapping relationship, and be taken as the fragment pixel information of the first mesh. In another implementations, the fragment pixel information of the first mesh may be obtained by performing interpolation based on the vertex pixel information of the first mesh. For example, for a grid in the first mesh, the pixel information of the grid may be obtained by performing interpolating on the pixel information of four vertices of the grid. In addition, the fragment pixel information of the first mesh may be determined by combining both the first mapping relationship and the vertex pixel information of the first mesh. For example, corresponding pixel information of a central region of the grid may be determined using the first mapping relationship, while edge positions of the grid are obtained by performing interpolation based on the vertex pixel information. These approaches may be flexibly adapted based on specific requirements, and are not limited herein.

At step B4, based on the vertex pixel information of the second mesh, a depth adjustment operation and a fragment edge feathering operation are performed on the fragment pixel information of the first mesh to obtain fragment pixel information of the second mesh.

It may be understood that after adjusting the vertex positions of the first mesh, the stereoscopic second mesh may have problems such as occlusion, sawtooth, etc. In order to solve this problem, the depth adjustment operation and the fragment edge feathering operation may be performed on the fragment pixel information of the first mesh based on the vertex pixel information of the second mesh. Specifically, the depth in the fragment pixel information of the first mesh may be adjusted based on the vertex depth indicated by the vertex pixel information of the second mesh, the transparency of edges of the fragment may be adjusted based on preset feathering parameters to finally obtain the fragment pixel information of the second mesh, and the fragment pixel information of the second mesh may include depth information, brightness information, RGBA color information and the like. Through the above method, the second mesh may have more reasonable and realistic fragment pixel information. In practical application, a vertex shader may be used for processing the vertices of the mesh, such as adjusting positions of the vertices of the mesh, to determine the vertex pixel information, etc.; and a fragment shader may be used for processing the mesh fragment, such as performing the depth adjustment operation and the fragment edge feathering operation, to determine the fragment pixel information, etc.

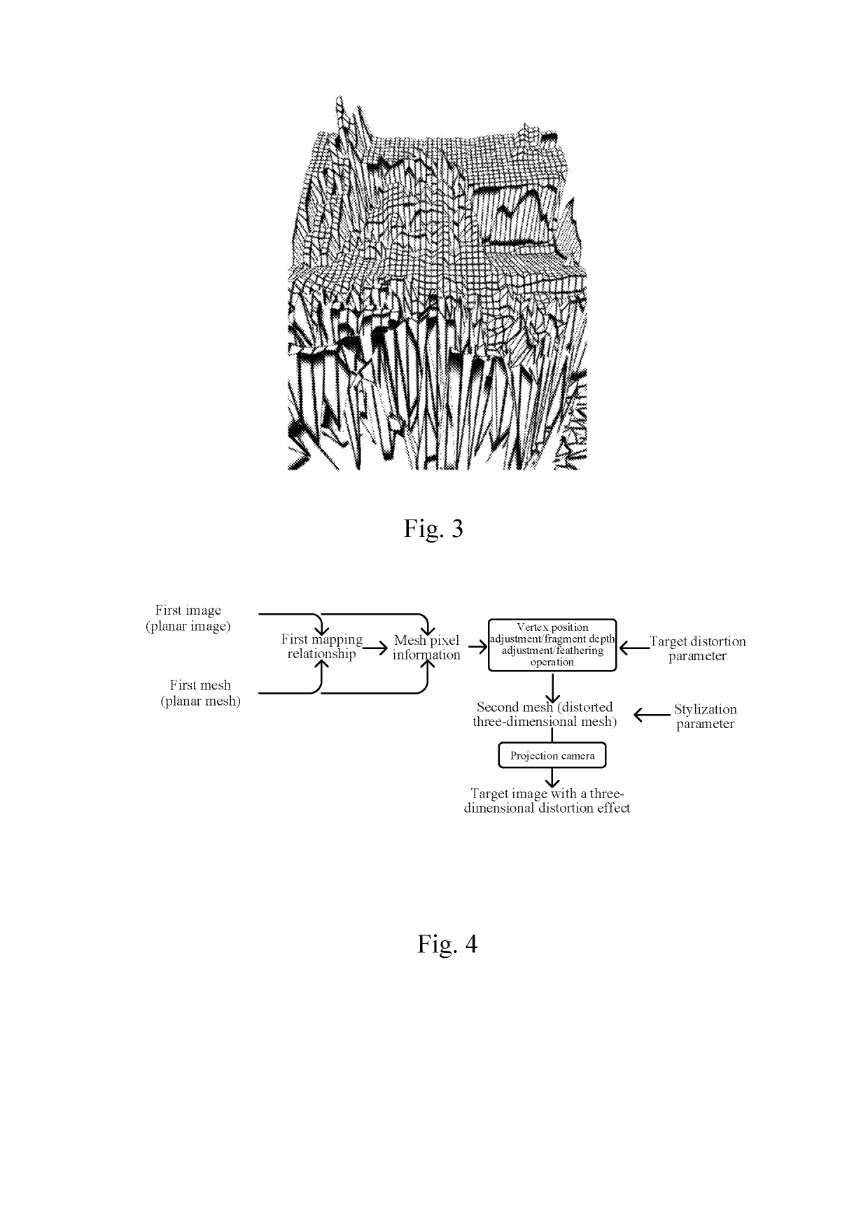

At step B5, the second mesh is obtained based on the vertex pixel information and the fragment pixel information of the second mesh. On the basis of the first mesh, by combining the vertex pixel information and the fragment pixel information of the second mesh, it may be directly converted into the second mesh. For the convenience of understanding, reference may be made to a schematic diagram of a second mesh shown in FIG. 3, which shows a mesh distortion example without displaying original image information. Compared with the first mesh, the second mesh is more stereoscopic, and the distortion effect is related to the pixel information in the first image, so that features in the first image may be better presented, which facilitates further realizing the effect of three-dimensional distortion of the target object in the first image.

In some embodiments, the step B5 may be executed with reference to the following steps B5.1 to B5.3.

At step B5.1, a preset stylization parameter is obtained, where the stylization parameter includes a first parameter and/or a second parameter, the first parameter indicates that target edge lines of the second mesh are subjected to transparency processing, and the second parameter indicates that a target fragment of the second mesh is subjected to transparency processing. Target edge lines and target fragments may be determined based on a preset image mesh (also called a preset stylization grid). The number of target edge lines and target fragments may be multiple. The size and number of meshes in the image mesh may determine size and number of target fragments, and the edge lines in the image mesh may determine the target edge lines. In practical application, the stylization parameter may be set flexibly. For example, by setting the mesh size and the number of meshes of the above-mentioned image mesh, the target edge lines and the target fragments of the second mesh may be determined. Then, it is decided whether to perform transparency processing on the target edge lines or target fragments of the second mesh, based on whether the stylization parameter includes the first parameter or the second parameter.

At step B5.2, transparency in the vertex pixel information and the fragment pixel information of the second mesh are adjusted based on the stylization parameter. By performing the transparency processing on the target edge lines and/or the target fragments, the second mesh may present a mesh scale-like perception that only the mesh fragments are displayed, or a mesh line-like perception that only the mesh edge lines are displayed.

At step B5.3, the second mesh is obtained based on the vertex pixel information and the fragment pixel information of the second mesh after transparency adjustment. The second mesh may present a stylization effect that at least a part of edge lines is transparent or at least a part of fragments are transparent. In practical application, the user may be provided with a function option of whether to use a mesh style; when the user triggers this option, the above steps B5.1 to B5.3 will be executed, otherwise, the above steps need not be executed. The stylization parameter may be set by the user, for example, the first parameter and/or the second parameter may be set directly by the user, or the parameters of the image mesh may be set by the user, and the first parameter and/or second parameter are generated based on the parameters of the image mesh and the stylization effect selected by the user (only displaying the edge lines or only displaying the mesh fragments).

On the basis that the second mesh is obtained, the embodiment of the present disclosure provides an implementation example of generating the target image based on the second mesh, which may be executed with reference to the following steps a and b.

At step a, parameter information of a projection camera is obtained, where the parameter information includes an observation angle and a focal length, the observation angle indicates a viewing angle of the projection camera relative to the second mesh, and the focal length indicates a distance between the projection camera and the second mesh. The projection camera refers to a virtual camera used to capture a three-dimensional scene and render it on a two-dimensional screen, which may be used to define specific parameters of projection transformation such as an observation angle and a focal length.

At step b, screen display processing is performed on the second mesh based on the parameter information of the projection camera to obtain the target image.

Based on the parameter information of the projection camera and MVP transformation processing, the second mesh may be rendered and displayed on a two-dimensional screen to obtain the target image. Specifically, MVP transformation represents the combination of three steps: Model (model transformation), View (view transformation) and Projection (projection transformation), which together determine how a three-dimensional model (second mesh) is rendered onto a two-dimensional screen. Specifically, model transformation (Model) is responsible for transforming the second mesh from its local coordinate system to the world coordinate system, and usually includes rotation, scaling and translation operations to adjust a position, direction and size of the second mesh. View transformation (View) is also called camera transformation or observation transformation, which may simulate the position and orientation of the camera and transform the whole world coordinate system relative to the camera, thus realizing the observation of the second mesh from the camera's perspective. Projection transformation (Projection) projects points in the three-dimensional space into a two-dimensional plane by orthogonal projection or perspective projection. In practical application, a projection matrix may be constructed based on the parameter information of the projection camera, and then multiplied by a model matrix and a view matrix to generate a final MVP matrix. The MVP matrix may be used to transform each vertex of the second mesh, so as to complete the mapping from the three-dimensional space to a two-dimensional screen and generate the target image.

In practical application, the parameter information of the projection camera may be flexibly set, such as changing the observation angle and the focal length of the projection camera to change the viewing angle, so as to achieve a multi-angle presentation effect of the target object in the first image.

For the convenience of understanding, for example, reference may be made to a diagram of an image processing flow shown in FIG. 4, which shows that the first mapping relationship may be determined based on the first image (planar image) and the constructed first mesh (planar mesh), and then the mesh pixel information of the first mesh may be determined based on the first mapping relationship and the first image. Specifically, the vertex pixel information may be first determined by the vertex shader, and the fragment pixel information may be determined by the fragment shader. By performing vertex position adjustment, fragment depth adjustment, feathering operation, and other processing in combination with the target distortion parameter (such as the distortion axis and the maximum distortion angle) and the mesh pixel information, and then in combination with the stylization parameter, the second mesh, that is, the distorted three-dimensional mesh, may be obtained. Then, the second mesh in the three-dimensional space may be mapped to and displayed on the two-dimensional screen through the projection camera, thus presenting the target image with the three-dimensional distortion effect.

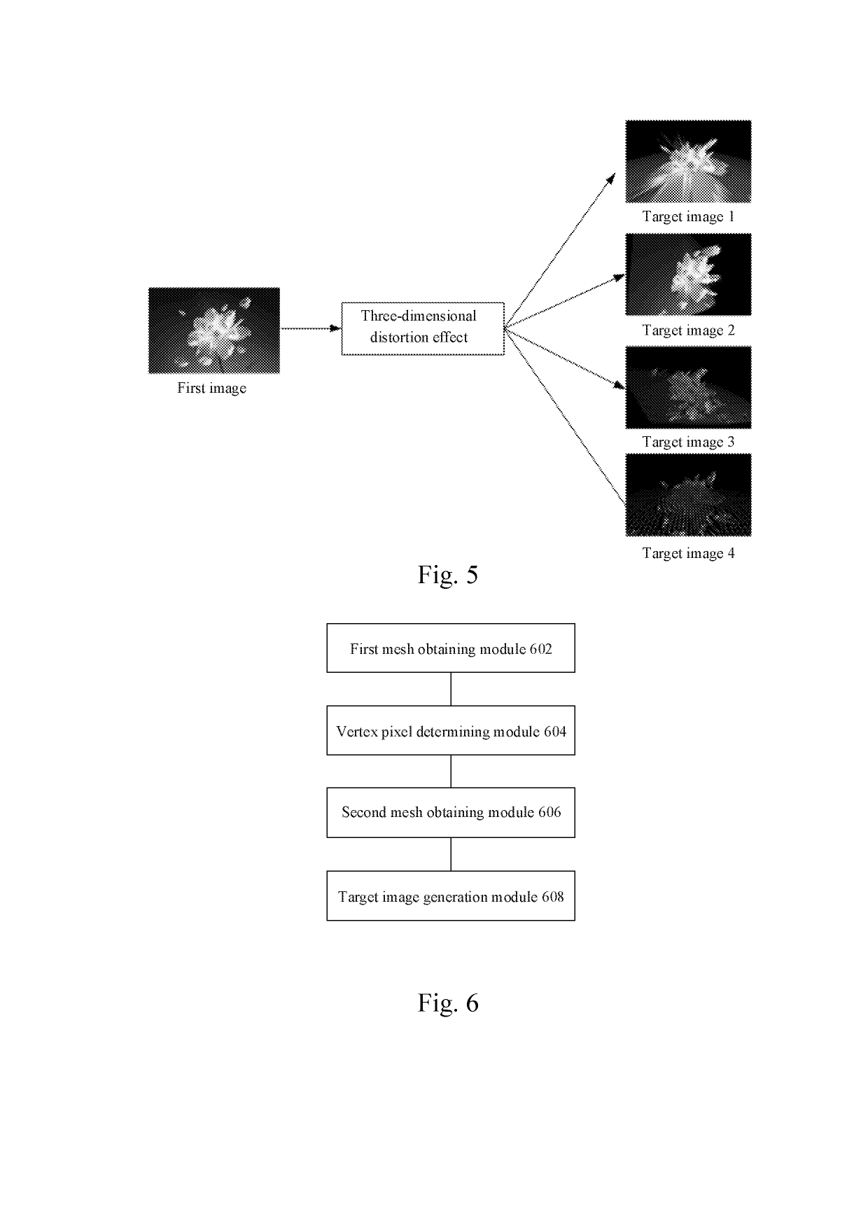

With reference to a schematic diagram of an image processing effect shown in FIG. 5, it shows that the first image may form different three-dimensional distortion effects by three-dimensional distortion effect processing (implemented by the image processing method according to the embodiment of the present disclosure), for example, by adopting different parameters such as the target distortion parameter, the parameters of the projection camera, the stylization parameter, etc. In FIG. 5, there are four effects of target images 1 to 4 in total, in which the target image 1 and the target image 2 do not adopt the stylization parameter, and a distortion perception of three-dimensional flowers from different perspectives may be presented to users mainly based on different target distortion parameters and parameters of the projection camera. The target image 3 and the target image 4 adopt different stylization parameters. The target image 3 mainly presents mesh edge lines, and the mesh fragments are subjected to transparency processing and no longer present corresponding pixel colors, thus presenting a mesh-line perception as a whole. The target image 4 mainly presents mesh fragments, and the mesh edge lines are subjected to transparency processing and no longer present corresponding pixel colors, thus presenting a mesh scale-like perception as a whole. Through the above-mentioned three-dimensional distortion effect, the target image with strong interest, appeal and visual impact may be obtained, thus meeting the requirements of users for three-dimensional distortion effects.

It may be understood that in the related art, planar distortion is basically only applied on planar images. But in the above-mentioned method according to the embodiment of the present disclosure, the pixel information of a planar image may be first projected onto a planar mesh, and then the mesh vertices may be adjusted in combination with distortion parameters to obtain a three-dimensional stereoscopic mesh, and then a target image with the three-dimensional distortion effect may be obtained through projection. The above method is easy to be implemented. By adjusting parameters such as distortion parameters and stylization parameters, the objects in the planar image may be distorted in different forms in the three-dimensional space, so as to obtain diversified target images with a three-dimensional distortion effect. Moreover, the viewing angle may be changed in the three-dimensional space by adjusting parameters of a projection camera and so on, and the objects in the planar image may be presented three-dimensionally from multiple viewing angles, thus providing users with three-dimensional distortion effects with rich visual effects.

Corresponding to the aforementioned image processing method, an embodiment of the present disclosure further provides an image processing apparatus, and FIG. 6 is a structural schematic diagram of an image processing apparatus according to the embodiment of the present disclosure, which may be implemented by software and/or hardware and may generally be integrated in an electronic device. As shown in FIG. 6, the image processing apparatus includes a first mesh obtaining module 602, a vertex pixel determining module 604, a second mesh obtaining module 606 and a target image generation module 608.

The first mesh obtaining module 602 is configured to obtain a first image to be processed and a first mesh;

The vertex pixel determining module 604 is configured to determine a first mapping relationship between the first image and the first mesh, and determine vertex pixel information of the first mesh based on the first mapping relationship and the first image;

The second mesh obtaining module 606 is configured to obtain target distortion parameters, and adjust positions of vertices of the first mesh in a three-dimensional space based on the vertex pixel information of the first mesh and the target distortion parameters to obtain a second mesh; and

The target image generation module 608 is configured to generate a target image based on the second mesh.

According to the apparatus according to the embodiment of the present disclosure, the first mapping relationship between the first image and the first mesh may be determined first, then the vertex pixel information of the first mesh may be determined based on the first mapping relationship and the first image, and further the positions of the vertices of the first mesh in the three-dimensional space may be adjusted based on the vertex pixel information of the first mesh and the target distortion parameter, so that the second mesh distorted in the three-dimensional space may be obtained, and the target image with the three-dimensional distortion effect may be obtained based on the second mesh, thereby providing users with three-dimensional distortion effects to meet image effect requirements of the users.

In some implementations, the first mesh obtaining module 602 is specifically configured to: respectively construct corresponding sub-meshes by using a plurality of processes, where the sub-meshes include planar mesh with M rows and N columns with both M and N being preset positive integers; and merge the plurality of the sub-meshes to obtain the first mesh.

In some implementations, the first mesh is a planar mesh, and the vertex pixel determining module 604 is specifically configured to: determine the first mapping relationship based on information of a ratio between a size of the first image and a size of the first mesh.

In some implementations, the vertex pixel determining module 604 is specifically configured to: determine a sampling position corresponding to a vertex of the first mesh, determine a pixel corresponding to the sampling position in the first image based on the first mapping relationship, and take pixel information of the pixel as vertex pixel information of the first mesh, where the pixel information of the pixel includes brightness information and/or color information of the pixel.

In some implementations, an abscissa of the sampling position corresponding to the vertex represents an abscissa of the vertex or an abscissa of a specified position of a fragment to which the vertex belongs in the first mesh; and an ordinate of the sampling position corresponding to the vertex represents an ordinate of the vertex or an ordinate of the specified position of the fragment to which the vertex belongs in the first mesh.

In some implementations, the target distortion parameters are preset adjustable parameters, the target distortion parameters include a distortion axis and a maximum distortion angle, and the maximum distortion angle is a maximum angle at which the vertex in the first mesh rotates around the distortion axis. The second mesh obtaining module 606 is specifically configured to: determine a target angle at which the vertex of the first mesh rotates around the distortion axis based on the vertex pixel information of the first mesh and the maximum distortion angle; and adjust the position of the vertex of the first mesh in the three-dimensional space based on the distortion axis and the target angle to obtain the second mesh.

In some implementations, the vertex pixel information includes a vertex brightness value or a vertex color value; and the second mesh obtaining module 606 is specifically configured to: obtain, based on the maximum distortion angle, a second mapping relationship between the vertex pixel information of the first mesh and the angle at which the vertex of the first mesh rotates around the distortion axis, where the second mapping relationship is characterized by a positive correlation function or a negative correlation function; and determine the target angle at which the vertex of the first mesh rotates around the distortion axis based on the vertex pixel information of the first mesh and the second mapping relationship.

In some implementations, the second mesh obtaining module 606 is specifically configured to: adjust the position of the vertex of the first mesh in the three-dimensional space based on the distortion axis and the target angle to obtain vertex position information of the second mesh; determine vertex pixel information of the second mesh based on the vertex position information of the second mesh and the vertex pixel information of the first mesh; determine fragment pixel information of the first mesh based on the first mapping relationship and/or the vertex pixel information of the first mesh; perform, based on the vertex pixel information of the second mesh, a depth adjustment operation and a fragment edge feathering operation on the fragment pixel information of the first mesh to obtain fragment pixel information of the second mesh; and obtain the second mesh based on the vertex pixel information and the fragment pixel information of the second mesh.

In some implementations, the second mesh obtaining module 606 is specifically configured to: obtain a preset stylization parameter, where the stylization parameter includes a first parameter and/or a second parameter, the first parameter indicates that target edge lines of the second mesh are subjected to transparency processing, and the second parameter indicates that a target fragment of the second mesh is subjected to transparency processing; adjust transparency in the vertex pixel information and the fragment pixel information of the second mesh based on the stylization parameter; and obtain the second mesh based on the vertex pixel information and the fragment pixel information of the second mesh after transparency adjustment.

In some implementations, the target image generation module 608 is specifically configured to: obtain parameter information of a projection camera, where the parameter information includes an observation angle and a focal length, the observation angle is configured to indicate a viewing angle of the projection camera relative to the second mesh, and the focal length is configured to indicate a distance between the projection camera and the second mesh; and perform screen display processing on the second mesh based on the parameter information of the projection camera to obtain the target image.

The image processing apparatus according to the embodiment of the present disclosure may execute the image processing method according to any embodiment of the present disclosure, and has corresponding functional modules and beneficial effects.

It may be clearly understood by those skilled in the art that for the convenience and conciseness of description, specific working processes of the apparatus embodiment described above may refer to the corresponding processes in the method embodiment, which are omitted here.

An embodiment of the present disclosure provides an electronic device. The electronic device includes: a memory having stored thereon a computer program; and a processing apparatus configured to execute the computer program in the memory to implement the steps of any method in the present disclosure.

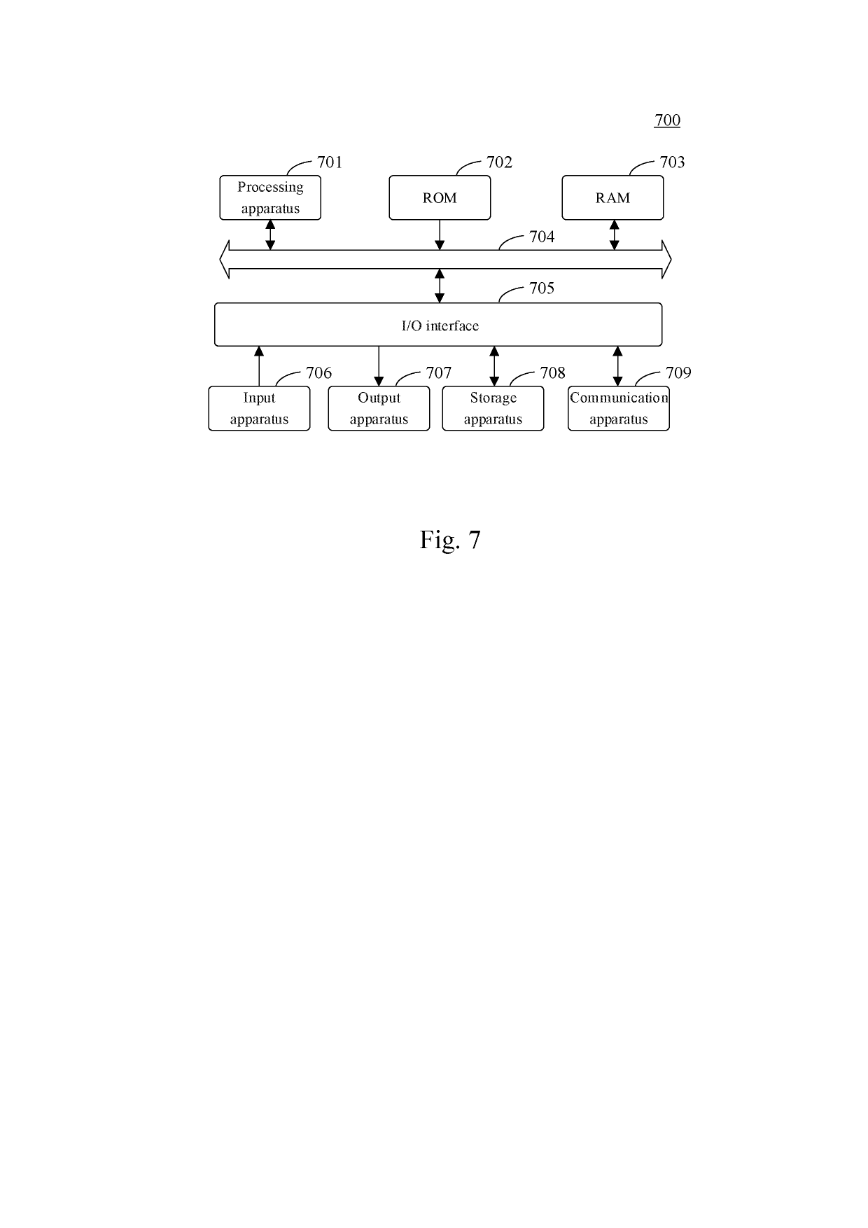

Referring to FIG. 7, FIG. 7 illustrates a schematic structural diagram of an electronic device 700 suitable for implementing some embodiments of the present disclosure. The terminal devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 7 is merely an example, and should not pose any limitation to the functions and the range of use of the embodiments of the present disclosure.

As illustrated in FIG. 7, the electronic device 700 may include a processing apparatus 701 (e.g., a central processing unit, a graphics processing unit, etc.), which may perform various suitable actions and processing according to a program stored in a read-only memory (ROM) 702 or a program loaded from a storage apparatus 708 into a random-access memory (RAM) 703. The RAM 703 further stores various programs and data required for operations of the electronic device 700. The processing apparatus 701, the ROM 702, and the RAM 703 are interconnected by means of a bus 704. An input/output (I/O) interface 705 is also connected to the bus 704.

Usually, the following apparatus may be connected to the I/O interface 705: an input apparatus 706 including, for example, a touch screen, a touch pad, a keyboard, a mouse, a camera, a microphone, an accelerometer, a gyroscope, or the like; an output apparatus 707 including, for example, a liquid crystal display (LCD), a loudspeaker, a vibrator, or the like; a storage apparatus 708 including, for example, a magnetic tape, a hard disk, or the like; and a communication apparatus 709. The communication apparatus 709 may allow the electronic device 700 to be in wireless or wired communication with other devices to exchange data. While FIG. 7 illustrates the electronic device 700 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 709 and installed, or may be installed from the storage apparatus 708, or may be installed from the ROM 702. When the computer program is executed by the processing apparatus 701, the above-mentioned functions defined in the methods of some embodiments of the present disclosure are performed.

In addition to the above method and device, an embodiment of the present disclosure may also provide a computer program product, including computer program instructions which, when executed by a processor, cause the processor to perform the method according to the embodiment of the present disclosure. The computer program product may write program codes for performing the operations of the embodiments of the present disclosure in any combination of one or more programming languages, including object-oriented programming languages such as Java, C++, and conventional procedural programming languages such as "C" or similar programming languages. The program codes may be completely executed on a user computing device, partially executed on the user device, executed as an independent software package, partially executed on the user computing device and partially executed on the remote computing device, or completely executed on the remote computing device or a server.

In addition, an embodiment of the present disclosure may also provide a computer-readable storage medium having stored thereon computer program instructions which, when executed by a processor, cause the processor to execute the image processing method according to the embodiment of the present disclosure.

The computer-readable storage medium may adopt any combination of one or more readable medium. The readable medium may be a readable signal medium or a readable storage medium. The readable storage medium may include, for example, but not limited to, an electrical, magnetic, optical, electromagnetic, infrared, or semiconductor system, apparatus or device, or a combination of any of the above. More specific examples (a non-exhaustive list) of the readable storage medium include: an electrical connection with one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

An embodiment of the present disclosure also provides a computer program product, including computer programs/instructions, which, when executed by a processor, implement the image processing method in the embodiment of the present disclosure.

For example, when receiving an active request from a user, a prompt message is sent to the user to explicitly prompt the user that an operation requested by the user will need to obtain and use the user's personal information. In this way, the user may choose whether to provide personal information to a software or hardware such as an electronic device, an application, a server, or a storage medium that performs the operation of the technical solution of the present disclosure according to the prompt message.

As an optional but non-limiting implementation, in response to receiving an active request from a user, the prompt message may be sent to the user in the form of a pop-up window, and the prompt message may be presented in the pop-up window in the form of text. In addition, the pop-up window may also carry a selection control for the user to select "agree" or "disagree" to provide personal information to the electronic device.

It may be understood that the above process of notifying and obtaining user authorization is only schematic, and does not limit the implementation of the present disclosure. Other manners that meet relevant laws and regulations may also be applied to the implementation of the present disclosure.

It is to be noted that the relationship terms, such as “first” and “second”, are used herein only for distinguishing one entity or operation from another entity or operation but do not necessarily require or imply that there exists any such actual relationship or sequence between these entities or operations. Also, the terms “comprise”, “include”, or any other variation thereof, are intended to cover a non-exclusive inclusion, such that a process, method, article, or device that includes a list of elements does not include only those elements but also may include other elements not expressly listed or inherent to such process, method, article, or device. Without further limitation, an element defined by the phrase “comprising an ...” does not exclude the presence of other identical elements in the process, method, article, or device that includes the element.

The previous description is only for the purpose of describing particular embodiments of the present disclosure, so as to enable those skilled in the art to understand or implement the present disclosure. Many modifications to these embodiments will be obvious to those skilled in the art, and the general principles defined herein may be implemented in other embodiments without departing from the spirit or scope of the present disclosure. Therefore, the present disclosure will not be limited to the embodiments described herein, but is to be accorded the widest scope consistent with the principles and novel features disclosed herein.

1. An image processing method, comprising:
obtaining a first image to be processed, and obtaining a first mesh;
determining a first mapping relationship between the first image and the first mesh, and determining vertex pixel information of the first mesh based on the first mapping relationship and the first image;
obtaining a target distortion parameter, and adjusting a position of each of vertices of the first mesh in a three-dimensional space based on the vertex pixel information of the first mesh and the target distortion parameter to obtain a second mesh; and
generating a target image based on the second mesh.

2. The image processing method according to claim 1, wherein the obtaining the first mesh, comprises:
respectively constructing corresponding sub-meshes by using a plurality of processes, wherein the sub-meshes comprises planar meshes with M rows and N columns, and both M and N are preset positive integers; and
merging a plurality of the sub-meshes to obtain the first mesh.

3. The image processing method according to claim 1, wherein the first mesh is a planar mesh, and the determining the first mapping relationship between the first image and the first mesh, comprises:
determining the first mapping relationship based on information of a ratio between a size of the first image and a size of the first mesh.

4. The image processing method according to claim 1, wherein the determining vertex pixel information of the first mesh based on the first mapping relationship and the first image, comprises:
determining a sampling position corresponding to each of the vertices of the first mesh, determining a pixel corresponding to the sampling position in the first image based on the first mapping relationship, and taking pixel information of the pixel as vertex pixel information of the first mesh, wherein the pixel information of the pixel comprises at least one selected from a group consisting of brightness information and color information of the pixel.

5. The image processing method according to claim 3, wherein the determining vertex pixel information of the first mesh based on the first mapping relationship and the first image, comprises:
determining a sampling position corresponding to each of the vertices of the first mesh, determining a pixel corresponding to the sampling position in the first image based on the first mapping relationship, and taking pixel information of the pixel as vertex pixel information of the first mesh, wherein the pixel information of the pixel comprises at least one selected from a group consisting of brightness information and color information of the pixel.

6. The image processing method according to claim 4, wherein an abscissa of the sampling position corresponding to each of the vertices comprises an abscissa of each of the vertices or an abscissa of a specified position of a fragment to which each of the vertices belong in the first mesh; and
an ordinate of the sampling position corresponding to each of the vertices comprises an ordinate of each of the vertices or an ordinate of the specified position of the fragment to which each of the vertices belong in the first mesh.

7. The image processing method according to claim 1, wherein the target distortion parameter is a preset adjustable parameter, the target distortion parameter comprises a distortion axis and a maximum distortion angle, and the maximum distortion angle is a maximum angle at which each of the vertices in the first mesh rotates around the distortion axis; and
the adjusting the position of each of the vertices of the first mesh in the three-dimensional space based on the vertex pixel information of the first mesh and the target distortion parameter to obtain the second mesh, comprises:
determining a target angle at which each of the vertices of the first mesh rotates around the distortion axis based on the vertex pixel information of the first mesh and the maximum distortion angle; and
adjusting the position of each of the vertices of the first mesh in the three-dimensional space based on the distortion axis and the target angle to obtain the second mesh.

8. The image processing method according to claim 7, wherein the vertex pixel information comprises a vertex brightness value or a vertex color value, and the determining the target angle at which each of the vertices of the first mesh rotates around the distortion axis based on the vertex pixel information of the first mesh and the maximum distortion angle, comprises:
obtaining, based on the maximum distortion angle, a second mapping relationship between the vertex pixel information of the first mesh and the angle at which each of the vertices of the first mesh rotates around the distortion axis, wherein the second mapping relationship is characterized by a positive correlation function or a negative correlation function; and
determining the target angle at which each of the vertices of the first mesh rotates around the distortion axis based on the vertex pixel information of the first mesh and the second mapping relationship.

9. The image processing method according to claim 7, wherein the adjusting the position of each of the vertices of the first mesh in the three-dimensional space based on the distortion axis and the target angle to obtain the second mesh, comprises:
adjusting the position of each of the vertices of the first mesh in the three-dimensional space based on the distortion axis and the target angle to obtain vertex position information of the second mesh;
determining vertex pixel information of the second mesh based on the vertex position information of the second mesh and the vertex pixel information of the first mesh;
determining fragment pixel information of the first mesh based on at least one selected from a group consisting of the first mapping relationship and the vertex pixel information of the first mesh;
performing, based on the vertex pixel information of the second mesh, a depth adjustment operation and a fragment edge feathering operation on the fragment pixel information of the first mesh to obtain fragment pixel information of the second mesh; and
obtaining the second mesh based on the vertex pixel information and the fragment pixel information of the second mesh.

10. The image processing method according to claim 9, wherein the obtaining the second mesh based on the vertex pixel information and the fragment pixel information of the second mesh, comprises:
obtaining a preset stylization parameter, wherein the stylization parameter comprises at least one selected from a group consisting of a first parameter and a second parameter, the first parameter indicates that target edge lines of the second mesh are subjected to transparency processing, and the second parameter indicates that target fragments of the second mesh is subjected to transparency processing;
adjusting transparency in the vertex pixel information and the fragment pixel information of the second mesh based on the stylization parameter; and
obtaining the second mesh based on the vertex pixel information and the fragment pixel information of the second mesh after the transparency is adjusted.

11. The image processing method according to claim 1, wherein the generating the target image based on the second mesh, comprises:
obtaining parameter information of a projection camera, wherein the parameter information comprises an observation angle and a focal length, the observation angle indicates a viewing angle of the projection camera relative to the second mesh, and the focal length indicates a distance between the projection camera and the second mesh; and
performing screen display processing on the second mesh based on the parameter information of the projection camera to obtain the target image.

12. An electronic device, comprising:
a memory, wherein a computer program is stored on the memory; and
at least one processor configured to execute the computer program in the memory to implement an image processing method,
wherein the image processing method comprises:
obtaining a first image to be processed, and obtaining a first mesh;
determining a first mapping relationship between the first image and the first mesh, and determining vertex pixel information of the first mesh based on the first mapping relationship and the first image;
obtaining a target distortion parameter, and adjusting a position of each of vertices of the first mesh in a three-dimensional space based on the vertex pixel information of the first mesh and the target distortion parameter to obtain a second mesh; and
generating a target image based on the second mesh.

13. The electronic device according to claim 12, wherein the obtaining the first mesh, comprises:
respectively constructing corresponding sub-meshes by using a plurality of processes, wherein the sub-meshes comprises planar meshes with M rows and N columns, and both M and N are preset positive integers; and
merging a plurality of the sub-meshes to obtain the first mesh.

14. The electronic device according to claim 12, wherein the first mesh is a planar mesh, and the determining the first mapping relationship between the first image and the first mesh, comprises:
determining the first mapping relationship based on information of a ratio between a size of the first image and a size of the first mesh.

15. The electronic device according to claim 12, wherein the determining vertex pixel information of the first mesh based on the first mapping relationship and the first image, comprises:
determining a sampling position corresponding to each of the vertices of the first mesh, determining a pixel corresponding to the sampling position in the first image based on the first mapping relationship, and taking pixel information of the pixel as vertex pixel information of the first mesh, wherein the pixel information of the pixel comprises at least one selected from a group consisting of brightness information and color information of the pixel.

16. The electronic device according to claim 14, wherein the determining vertex pixel information of the first mesh based on the first mapping relationship and the first image, comprises:
determining a sampling position corresponding to each of the vertices of the first mesh, determining a pixel corresponding to the sampling position in the first image based on the first mapping relationship, and taking pixel information of the pixel as vertex pixel information of the first mesh, wherein the pixel information of the pixel comprises at least one selected from a group consisting of brightness information and color information of the pixel.

17. The electronic device according to claim 15, wherein an abscissa of the sampling position corresponding to each of the vertices comprises an abscissa of each of the vertices or an abscissa of a specified position of a fragment to which each of the vertices belong in the first mesh; and
an ordinate of the sampling position corresponding to each of the vertices comprises an ordinate of each of the vertices or an ordinate of the specified position of the fragment to which each of the vertices belong in the first mesh.

18. The electronic device according to claim 12, wherein the target distortion parameter is a preset adjustable parameter, the target distortion parameter comprises a distortion axis and a maximum distortion angle, and the maximum distortion angle is a maximum angle at which each of the vertices in the first mesh rotates around the distortion axis; and
the adjusting the position of each of the vertices of the first mesh in the three-dimensional space based on the vertex pixel information of the first mesh and the target distortion parameter to obtain the second mesh, comprises:
determining a target angle at which each of the vertices of the first mesh rotates around the distortion axis based on the vertex pixel information of the first mesh and the maximum distortion angle; and
adjusting the position of each of the vertices of the first mesh in the three-dimensional space based on the distortion axis and the target angle to obtain the second mesh.

19. The electronic device according to claim 18, wherein the vertex pixel information comprises a vertex brightness value or a vertex color value, and the determining the target angle at which each of the vertices of the first mesh rotates around the distortion axis based on the vertex pixel information of the first mesh and the maximum distortion angle, comprises:
obtaining, based on the maximum distortion angle, a second mapping relationship between the vertex pixel information of the first mesh and the angle at which each of the vertices of the first mesh rotates around the distortion axis, wherein the second mapping relationship is characterized by a positive correlation function or a negative correlation function; and
determining the target angle at which each of the vertices of the first mesh rotates around the distortion axis based on the vertex pixel information of the first mesh and the second mapping relationship.

20. A non-transitory computer-readable storage medium storing a computer program for executing an image processing method,
wherein the image processing method comprises:
obtaining a first image to be processed, and obtaining a first mesh;
determining a first mapping relationship between the first image and the first mesh, and determining vertex pixel information of the first mesh based on the first mapping relationship and the first image;
obtaining a target distortion parameter, and adjusting a position of each of vertices of the first mesh in a three-dimensional space based on the vertex pixel information of the first mesh and the target distortion parameter to obtain a second mesh; and
generating a target image based on the second mesh.
